(19) United States
(12) Patent Application Publication
(10) Pub. No.: US 2007/0250501 A1
(43) Pub. Date: Oct. 25, 2007

(54) SEARCH RESULT DELIVERY ENGINE

(76) Inventors: Michael L. Grubb, San Francisco, CA (US); Ledio Ago, San Leandro, CA (US)

Correspondence Address: IRELL & MANELLA LLP, 1800 AVENUE OF THE STARS, SUITE 900, LOS ANGELES, CA, 90067, US

(21) Appl. No.: 11/670,904

(22) Filed: Feb. 2, 2007

Related U.S. Application Data
(63) Continuation-in-part of application No. 11/535,914, filed on Sep. 27, 2006.
(60) Provisional application No. 60/721,311, filed on Sep. 27, 2005.
(60) Provisional application No. 60/723,812, filed on Oct. 5, 2005.
(60) Provisional application No. 60/765,408, filed on Feb. 2, 2006.

(51) Int. Cl. G06F 17/30

(52) U.S. Cl. 707/5; 707/E17.017

(57) ABSTRACT

A method of delivering search results may include segmenting a query to obtain one or more word groups, such as nGrams, analyzing each word group to determine a degree of relatedness between that word group and a group of Internet websites related to each other by a common factor, for example by matching hash tables of bigrams, and applying each word group to a secondary index of words in the group of related websites to produce a set of search results which may be combined with another set of search results for the searcher.

### CROSS REFERENCE TO RELATED APPLICATIONS

This application is a continuation in part of U.S. patent application Ser. No. 11/535,914, filed Sep. 27, 2006 which claims the benefit of U.S. provisional application Ser. No. 60/721,311 filed Sep. 27, 2005 and Ser. No. 60/723,812 filed Oct. 5, 2005 and this application also claims the benefit of U.S. provisional application Ser. No. 60/765,408, filed Feb. 2, 2006.

### BACKGROUND OF THE INVENTION

1. Field of the Invention

This invention is related to Internet search engines and in particular to search results delivery engines.

2. Description of the Prior Art

Internet users are provided with search results, typically in the form of uniform resource locator (URL) addresses of web sites, during Internet searching on search engine sites. What are needed are improvements in searching and search results delivery.

### BRIEF DESCRIPTION OF THE DRAWING(S)

FIG. 1 is a block diagram overview of an Internet book marking system and an associated search result delivery engine.

FIG. 2 is a block diagram overview of a more general search results delivery enhancement engine based on the system of FIG. 1.

FIG. 3 is a block diagram overview of a query segmentation search result delivery engine.

FIG. 4 is a block diagram of portions of an embodiment of a query segmentation and comparison system for FIG. 3.

FIG. 5 is a block diagram of a results enhancement engine.

FIG. 6 is a high level function overview of query segmentation engine 86.

### SUMMARY OF THE INVENTION

A method of delivering search results may include applying a query from a searcher to a primary index of words on Internet websites to produce a first set of search results, segmenting the query to obtain one or more word groups, each word group including a predetermined number of words, analyzing each word group to determine a degree of relatedness between that word group and a group of Internet websites related to each other by a common factor, applying each word group to a secondary index of words in the group of related websites, if that word group has a predetermined level of relatedness to the group of related websites, to produce a second set of search results and combining the first and second set of search results to produce a combined set of search results for the searcher.

The common factor may be related to subject matter common to the group of related websites. The degree of relatedness may be determined by comparing the word group to the secondary index of the related group of websites. The common factor may be that each of the common websites is primarily news website and determining the timeliness of the word group with respect to current news may be by determining if the word group is present in news provided on a substantial number of the news websites in the group during a predetermined time period before the word group is analyzed.

The query may be segmented by identifying a pattern including the predetermined number of words which may include identifying an order in which the predetermined number of words appear in the query. Text associated with each website in the group of related websites may be segmented into word groups having the same number of predetermined words to form the secondary index and/or by identifying a pattern in an order of appearance of the predetermined number of words.

A method of delivering search results may include segmenting a query into one or more nGrams, each nGrams having n words, such as 2, appearing in a predetermined sequence, forming a table of nGrams appearing in at least one group of websites and providing a search result set in response to the query from the at least one group of websites if the query nGrams have a sufficient match to the nGrams of the at least one group of websites. Hash tables of the query nGrams may be matched to hash tables of the n-grams of the at least one group of websites and the hash tables for nGrams of the at least one group of websites may be updated and maintained, for example, by analyzing the at least one group of websites to identify nGram patterns, forming an index of the nGram patterns and maintaining a hash table of the index of nGram patterns.

A search result set may be provided by determining the relatedness of the query nGrams to nGrams of each of the plurality of groups of websites and providing search results from each of the plurality of groups of websites having a predetermined level of relatedness between nGrams of that groups of websites and the query nGrams. The predetermined level of relatedness may be different between different ones of the plurality of groups of websites. The websites in a group may be related to each other by a common factor, such as a news, travel or financial data website. The predetermined level of relatedness may be related to how recently the nGrams appeared in each such news website. The common factor in one of the predetermined groups of websites may be that each such websites is a travel or financial data website.

### DETAILED DESCRIPTION OF THE EMBODIMENT(S)

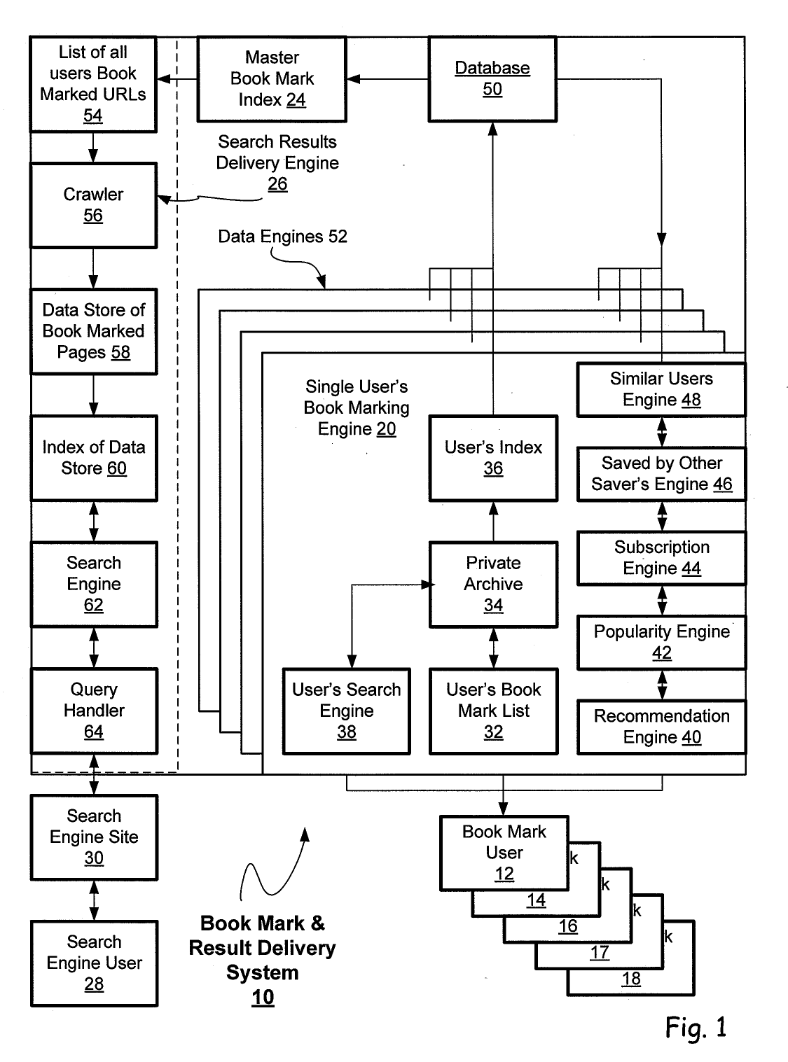

Referring now to FIG. 1, book mark and result delivery system 10 includes a book marking engine, one instantiation of which for user 12 is shown as book marking engine 20. Similar instantiations of single user's book mark engine 20 are available for other users such as book mark users 14, 16 and 18 to record and revisit web sites located by connection to the World Wide Web on the Internet or similar networking systems. Each instantiation of book marking engine may include a separate book mark user's index, such as index 36, or a common or master book mark index 24 may preferably be used which includes all the indexed information for all book mark users.

Book mark and result delivery system 10 may also include search result delivery engine 26 which may provide search results to search engine user 28 via search engine site 30.

Single user's book marking engine instantiation 20 may be used by book mark user 12 to save any item having a World Wide Web URL, such as a web site found by searching for example via search engine site 30. The title and link to each saved item may be saved in user's book mark list 32 and may be presented to user 12 when appropriate as a book mark or favorite site. The full-text of the book marked item, that is, the full text available at the book marked URL, may be saved or cached in a private repository such as private archive 34. User 12 has full access to private archive 34, but no other user is permitted to access the cached copies in private archive 34.

An index, such as user's index 36, may be built from the full-text of every cached item in private archive 34 for each user. This enables user 12, for example, to perform a search via user's search engine 38 of private archive 34. Items in private archive 34 matching items in a query from user's search engine 38 are presented as search results to user 12, for example, in a list. User 12 may then selectively retrieve either the cached copy of any of the search results listed or access the then-currently-available version of the item at the original URL at the source web site. In some circumstances, the cached copy and the item then currently available at the source web site may be different because the cached copy is a copy made at an earlier time.

Single user's book marking engine 20 may also provide recommendations to user 12 via recommendation engine 40 of items that may be of interest to user 12. Although various forms of recommendations may be made and/or delivered in various ways, four specific types of recommendations are disclosed as exemplars. In particular, recommendations may be selected or compiled by popularity engine 42, subscription engine 44, saved by other saver's engine 46 and similar users engine 48.

Book marks, and their corresponding items, may be marked private by the originating book mark user and therefore may not be shown to others. Such book marks and saved items marked private are not considered to be public and are therefore not included in recommendation lists from recommendation engine 40. If, however, a book mark or saved item is marked private by one user and not by another, the book mark and saved item not marked private may be considered to be public and included in recommendations provided by engine 40.

Popularity engine 42 may provide lists via recommendation engine 40 to users, such as user 12, of public URLs and saved items that have been selected because they meet certain criteria (such as, “most popular today” or “most recently saved”). Such lists can be derived and displayed in real-time, on a web site or via a syndication protocol such as RSS. For example, the top ten most popular URLs may be a list of the ten URL's which have been publicly bookmarked by more book mark users, such as user 12, during the last period, such as the most recent 24 hours or during the current calendar day.

Recommendations, or notices including such recommendations such as emails, may be automatically sent to book mark users, such as user 12, on a predetermined basis or as a result of an action by the user such as logging onto system 10 or initiating a search.

Subscription engine 44 may permit a user, such as user 12, to subscribe to the public book marks and saved items of another user, such as user 14. For example, user 12 could then receive all book marks and items publicly saved by user 14. Recommendation engine 40 may cause book marks and items publicly saved by user 14 to be displayed to user 12 in different manners including in a list of headlines or other new item notifications for user 12, in an email notification to user 12 and/or upon request by user 12. When user 12 first initiates a subscription to bookmarks and items publicly saved by user 14, user 14 may be notified of the existence of the subscription. User 14 may be given the option of declining that subscription in which case user 12 will not be permitted to subscribe to user 14.

Saved by other savers engine 46 may also provide recommendations to user 12, for example, via recommendation engine 40. For example, when user 12 publicly book marks, saves, views, or otherwise accesses a particular item, engine 46 may determine that the same item was publicly saved, perhaps within a predetermined time period in the past, by other users, such as user 16 and user 17. User 12 may then be notified of other items saved by user 16 and user 17 that may be of interest to user 12. A search engine, such as user's search engine 38, may be used as a master search engine by system 10 to provide search engines for the users, or a simple key word searching or other engine not shown, may compare portions of the item saved by user 12 to the other items saved by user 16 and user 17 to determine the composition and ranking of the items to be provided to user 12 as recommendations based on the actions of user 16 and user 17.

Similar users engine 48 may also provide recommendations to user 12 for example via recommendation engine 40. Engine 48 compares the public book marking activity of other users to user 12 and identifies similar users to recommend, based on a number of criteria, such as URLs, domain names, descriptions, key word matches, and pattern of saving activity. For example, engine 48 may utilize a threshold level of similarity, such as the number of key word matches or the number of matching saved items, to identify another user, such as user 18, to have similar patterns of saving items to user 12. Thereafter engine 48 may cause user 12 to be notified of items saved by user 18.

Similarly, recommendation engine 40 may use other techniques to determine which other saved items, and other users, are most likely to be of interest to a particular user such as user 12, and provide user 12 with recommendations and/or notifications based on such determinations. This information may be provided to user 12 on a push basis, such as periodically or for otherwise occurring predetermined events such as the saving or other activity by user 12 or by other users, or on a pull basis such as by a request or search by user 12.

The items to be provided to user 12 may be ranked for example on the basis of the likelihood of their interest to user 12 and/or marked for example by color to indicate their ranking. For convenience, each recommended item may easily be selected or eliminated by user 12 from the recommendation results by clicking on an appropriate icon associated with each item.

Each recommendation type, such as recommendations based on popularity or similar patterns, may be provided to the user directly from each engine or via recommendation engine 40. In particular, engine 40 may combine various types of recommendations and combine them for example by ranking and/or the method (push or pull) and other details of providing them to the user.

User 12 may also be able to set preferences for each type of recommendation and combinations of recommendations. User 12 may also be permitted to search directly for other users based on first, last or user name. User 12 may also be permitted to directly view all book marks or saved items not marked private, including tags, ratings and other metadata supplied by the saving user.

All users, for each item that is saved, can specify metadata about the items including, but not limited to: title, tags, categories, topics, keywords, date, URL, referring URL, rating, comments, quotations from the item, author, publication date, source, ISBN or ISSN, library cataloging data, date stamps and/or bibliographic data. One or more of the metadata elements for a particular item may be supplied automatically by book marking engine 20 at the time of book marking or saving. For example, user 12 may decide that all items such as URLs accessed, viewed or saved between a first time and a second time should belong to a particular task, such as billing task #n. User 12 may then select a preference, including a start time, after which all such items would automatically have included in the metadata associated with each such item a reference to billing task #n. At the end of the search associated with billing task #n, user 12 may then select the time at the end of the search as a further preference or an actual stop time after which such items would no longer have a reference to billing task #n automatically added to the metadata for those items.

All users can search their own private archive, such as archive 34, and limit their search results by date, category, rating, or any other specified metadata. For example, user 12 may search the private archive for user 12 to retrieve all items whose metadata includes a reference to billing task #n.

Further, metadata to be automatically added to the metadata for particular items may be automatically derived from specified metadata in the item. For example, URLs in the item linking to a commercial site at which a product related to the saved item may be bought or sold may be added as metadata. Such URLs may be detected by recognizing URLs of prominent commercial sites such as amazon.com, ebay.com, etc. from a predetermined list. The metadata automatically inserted may be inserting an applicable affiliate code (i.e., a string inserted into the URL to identify a web site operator who receives a commission or payment of some kind related to commercial traffic driven to the site). Such URLs may also be constructed by recognizing books, magazines, and other commercial objects referenced on the saved or book marked document, and building a URL to purchase or sell said objects, including an applicable affiliate code, on a commercial site.

Such URL metadata may be used to cause the identified web site operator to receive a commission or other payment from a commercial site when user 28 performs an act, such as buying the specified item from the commercial site, which contractually requires payment from the commercial site to the web site operator providing the link to the commercial site to user 28.

All users may have access to functions of system 10, such as save, view, retrieve from cache, edit, search, find user, subscribe, view headlines, or other functions, via a web site interface or through an API (application programming interface) over the World Wide Web.

Access to data for recommendation engine 40, as well as engines 42, 44, 46 and 48, may be provided from data base 50, which receives public data from private archive 34 and/or user's index 36. Data may also be provided from master book mark index 24 which is an index of database 50.

Book mark and result delivery system 10 may also be used to deliver highly-relevant search results from a database of documents, such as database 50 and/or master index 24, based on the combination of all users book marking engines, such as engine 20. System 10 may include other sources of data, rather than the combination of user's engines, where the ranking of the data or results is dependent upon the voting, rating, and other metadata and activities of the users of the system, and where the document set itself is selected based on the activities of the users of the system.

For example, engine 20 may be one of a series of single user book marking engines forming data engines 52. Alternately, engines 52 may include other types of data engines as well as user engine 20 or engines 52 may include only other types of data engines or sources of data or results as long as the data or results includes ranking or other comparative data dependent on metadata at least in part supplied by, and/or are activities of, the users of the system and/or the items in the set of data and/or results are selected based on the actions of the users of the system.

In a preferred embodiment, data engines 52 provides a focused index of websites in the World Wide Web, that is the public Internet, built from items saved in the book marking system disclosed in which engine 20 is an exemplar of one of many single user's book marking and searching activities. Other types of book marking systems may also be used as well as other sources of such focused data. Similarly, database 50 may be a separate data base or a compilation or combination of indexes or the like, such as user's index 36, in data engines 52.

Similarly, master book mark index 24 may be a separate index as shown in FIG. 1 or a compilation of the various user's indexes. In any event, in operation, delivery engine 26 may start by extracting a list of URLs and/or other items together with data related to the saving of each URL or item. For example, in a system in which each data engine 52 is a single book mark user's engine such as engine 20, a list of all user's book marked URLs and/or other saved items may be extracted as list 54. List 54 may be considered to be a database in which metadata about the activities of the users is stored with each URL or other stored item, such as the number of users on data engines 52 which have book marked and/or saved each particular URL or other item. The metadata may include, or be computed to include meta ranking data, that is, data such as an average numeric ranking of each saved URL or other item indicating the quality of the URL or other item for a specific purpose.

Web crawler 56, or a software or other device using a similar technique, may then be used to collect and/or update a collection of saved copies of the URLs or other data collected by crawler 56, together with the ranking meta data from list 54 or from index 24, database 50 or otherwise from data engines 52, in a data store of book marked pages or other saved items, such as data store 58. Index 60 of data store 58 is then created or updated.

Search engine 62 may then access data store 60 in response to query handler 64 to determine matches or partial matches in data store 60 for queries received from search engine site 30. A result set from search engine 62, appropriately matching the query from search engine user 28, may be provided to user 28 directly by search engine site 30 or indirectly by conventional redirect mechanisms.

The results provided to user 28 may be ranked on various criteria including based on metadata ranking data provided as described above. Each result may be displayed with various information elements including data derived from the metadata ranking data as well as links back to a bookmark or other source system represented by engines 52.

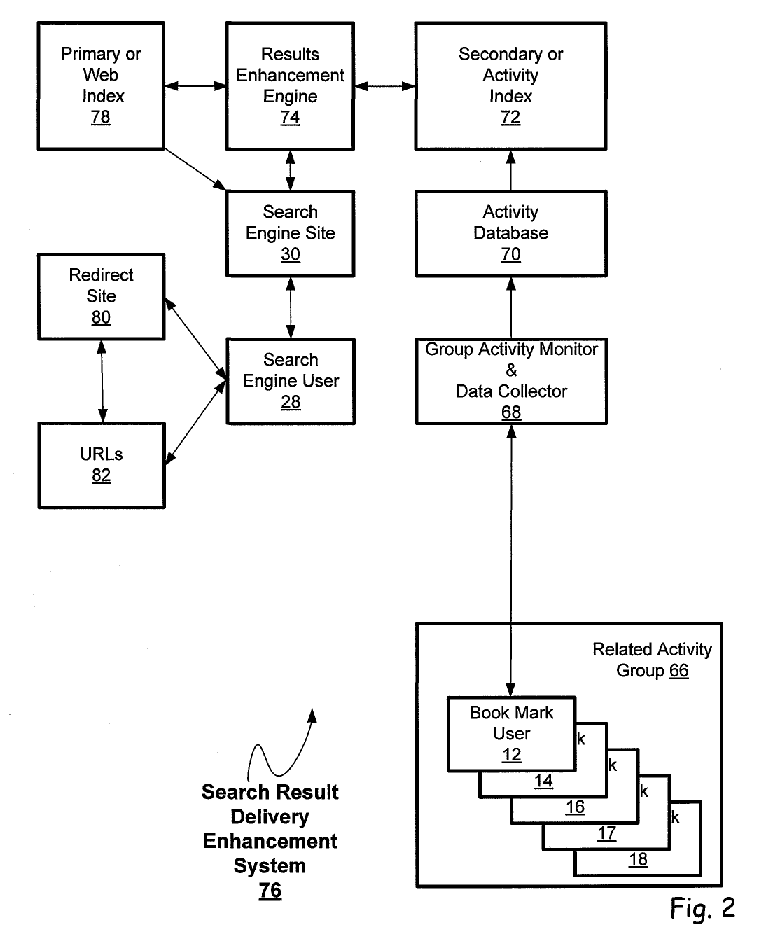

Referring now to FIG. 2, a more generic form of the system of FIG. 1 is described in which search results may be enhanced in search result enhancement system 76. A selected group of actors, such as book mark users 12, 14, 16 and 18, and/or the activities of a particular group acting in a known or predictable manner, may be monitored to collect data by group activity and data collector 68. In the embodiment described in FIG. 1, for example, the activity monitored may be the saving of particular items by book mark users. Other possible activity groups may be selected groups of web sites including search engines whose activities may be monitored. The data collected by monitor and data collector 68 may be saved in activity database 70 and then indexed in secondary or activity index 72 or the activity data may be indexed directly in secondary index 72 without the use of a separate database.

In any event, it may be preferable to build secondary index 72 before search engine user 28 queries search engine site 30.

Referring now to a conventional search which may be initiated by search engine user 28, search engine site 30 may retrieve search results from primary or web index 78 in response to the query from user 28, for example, by selecting entries in web index 78 which match key words or phrases derived from the query provided by user 28. Conventionally, search result sets may be returned to user 28 from search engine site 30 so that user 28 may view or download related URLs 82 directly or via a redirect site such as site 80. Many variations are known for conventional searching.

In accordance with this embodiment, the raw search result set from primary or web index 78 may be applied to results enhancement engine 74 for improvement before being provided to user 28. For example, the raw search results may be enhanced by ranking based on the contents of each indexed item in web index 78 (which may be considered to be an intrinsic ranking) and/or the raw search results may be enhanced by ranking based on the extraction of links within each indexed item in web index 78 (which may be considered to be an extrinsic ranking). In one embodiment, results enhancement engine 74 may simply add some of the content of secondary index 72 to the search results set provided to user 28, for example in fixed positions. The content from secondary index 72 may be selected by ranking, based on primary index 78 or secondary index 72. Extrinsic and/or intrinsic and/or ranking by voting may be applied to either or both the results of indexes 72 and 78. Further, the addition of data from secondary index 72 to the result set from primary index 78 is a form of secondary ranking, that is, ranking of the search results from a primary index in accordance with a secondary index from a selected group of sources.

Results from results enhancement engine 74, in addition to the use of such ranking techniques based on the items selected for the result set in accordance with the indexed URLs, may also be ranked or otherwise enhanced in engine 74 in accordance with secondary index 72. For example, as described above with regard to FIG. 1, URLs saved by bookmark users 12, 14, 16 and/or 18 which are indexed in secondary index 72 and bear some relationship to the query from user 28 by for example including one or more of the key words in that query, may be added to the result set provided to user 28.

Further, weighting based on the number of book mark users saving the same URL may be used to provide a further ranking of the result set to be provided to user 28. Still further, results enhancement engine 74 may be configured to selectively add results from secondary index 72 to the results set provided to search engine user 28 only or to the extent that such results bear some relationship to the query from user 28 by for example including one or more of the key words in that query.

The relationship between the results from secondary index 72 and the query may, for example, also be one of timeliness. For example, related activity group 66 may be a series of news web sites. The data collected from group 66 may be monitored, collected and stored so that secondary index 72 is periodically updated to include only new data; e.g. data that is less than a specified number of hours or days old. For example, secondary index 72 may be updated every four or eight hours to contain only news data that was current, such as news data no more than 24 or 48 hours old. Secondary index 72 may also include news data weighted by age, i.e. data less than 24 hours old may be weighted higher than data more than 24 hours old. This weighting may be used, in part, to determine the relationship between the query and the data in secondary index 72.

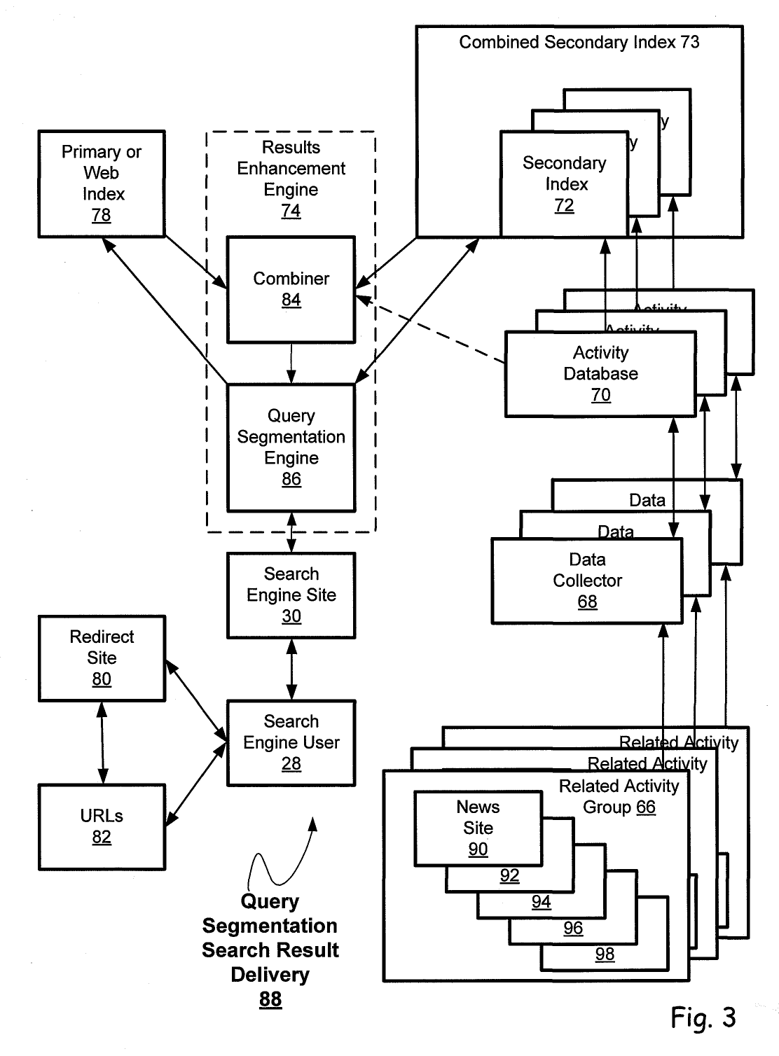

Referring now to FIG. 3, query segmentation search result delivery engine 88 includes search engine site 30 which responds to a search request from search engine user 28 by submitting a query to results enhancement engine 74. Results enhancement engine 74 may operate at least partially in a conventional search engine manner by comparing the search query from search engine site 30 with a primary index of potential search results, such as web index 78, which the operator of search engine site 30 has developed or otherwise obtained access to use. The search results from web index 78 which match or partially match the searchable information in the query are provided by search engine site 30 to search engine user 28 as a search result set directly, or via redirect site 80, so that by selecting portions of the provided search result set, user 28 obtains access to various search results such as URLs 82.

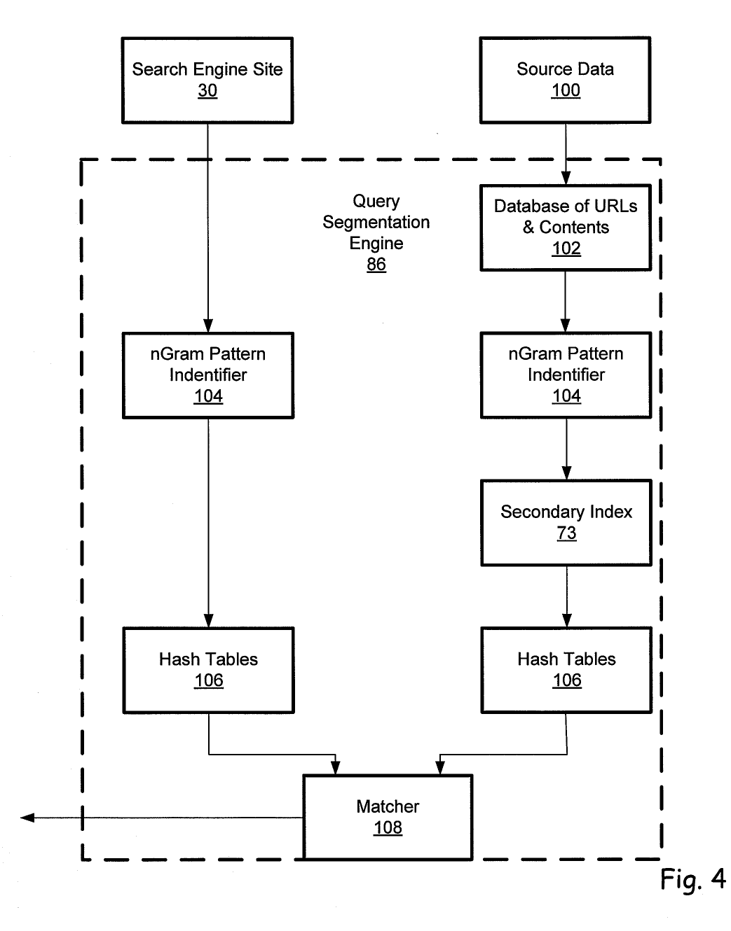

In addition, in a preferred embodiment, results enhancement engine 74 may be used to cause additional search results to be provided to user 28 in result to a search query. Engine 74 may determine that a predetermined relationship between the query and the data in secondary index 72 exists. A pointer to a source of the data in secondary index 72 may be included in secondary index 72, such as the source URL. In this case, URLs from secondary index 72 may be selectively added by engine 74 to the URLs selected from index 78. Alternately, for example to reduce latency, secondary index 72 may not include a pointer to the sources of the data. Upon a determination by engine 74 that a specified relationship exists between the query and the data in secondary index 72, that is, between the query and data extracted from related activity group 66, data from another source of data extracted from group 66, such as database 70 or data source 100 (shown below in FIG. 4), may be combined with the search results from web index 78 to provide a set of search results to user 28 which has been enhanced by data extracted from related group 66.

Further, a plurality of different groups 66 may be used. The data from each group 66 may be monitored, collected, stored and indexed in a secondary index such as index 72, and or in combined secondary index 73. Engine 74 may determine that one or more of the related activity groups 66 have an appropriate relationship with the query, based for example on a weighting or scoring factor that may be included in the data indexes 72 or 73. For example, a group related to travel and a group related to news may both be related to a query including segments related to “travel to Mexico”. In a preferred embodiment, the travel group may have a first scoring threshold for relatedness to the query while the news group has a different, second scoring threshold. If the scoring in the related index for both the travel and news groups exceed their thresholds, both may be determined to be related to the query. Similarly, a combined threshold for relatedness to more than one group, for example to travel and news, may be set lower than the sum of the thresholds for each group so that even if one or both of the groups did not achieve their individual group thresholds, the combination of the two groups might achieve the combined threshold for relatedness.**

For example, results enhancement engine 74 may be used to determine that the search query is likely to be related to a specific field of inquiry, such as current events, based for example on timeliness, that is, a matching between segments of the query and recent news data, e.g. less than 24 or 48 hours old. Results enhancement engine 74 may make that determination by evaluating one or more, and preferably multiple, segments of the search query provided by search engine 30 for user 28 in light of a secondary index of specialized search results such as secondary index 72. Secondary index 72 may include a ranked or scored set of data related to patterns, sorted by score selected, extracted or aggregated from a group formed of web sites having a related purpose or activity or other specialized relationship. The data may include or point to an indication of the source of the specific data or a database of such and the related sources may be separately provided. In this example, related activity group 66 may be a group of sites providing news, such as news sites 90, 92, 94, 96 and 98, which may include web sites or other sources of news services including web sites related to newspapers such as the NY Times, cable news networks such as CNN, other news services such as AP, and RSS news feeds.

A plurality of secondary indexes 72, each representing a different related activity group 66, may be combined in combined secondary index 73 for convenience, for example, to reduce the time required to determine which if any of the secondary indexes are related to the segments derived by query segmentation engine 86 from the original query. It should be noted that activity databases 70 may each represent a different data collector engine 68 and/or be combined to produce a combined database. Similarly, each related activity group 66 may be combined to produce a combined related activity group.

The selection of the Internet web sites and services selected for each particular related activity group may be an important aspect of the value of the result set enhancement available from results enhancement engine 78. For example, the types of sites or sources selected to be in a particular related activity group may be selected in accordance with the reasons such sites or sources operate. The selection of one or more groups of individuals who are bookmarking favorite sites or other information for their own personal reasons, as discussed above with respect to FIG. 1, enhances the likelihood that the popularity of particular sites saved by the selected group or groups will accurately reflect the general popularity of the bookmarked data such as websites. In the present example, the purpose of results enhancement engine 74 may be to provide an enhancement related to current news by selecting a group of respected news sources especially if the selected group was a representative cross section of news sources.

Additional potential sources for use by an enhancement engine may include information related to products with standardized identification numbers, such as books, music, movies, cars, electronics equipment, etc.; any digital media, including photos, videos, audio, podcasts, movies, television shows, etc.; job openings, jobs wanted, resumes; local services and shopping, such as restaurants, healthcare providers, stores; real estate listings; for sale or rent classifieds; and so forth.

Alternately, results enhancement engine 74 might be used to enhance results in a different manner by providing additional search results which were selected on the basis of a more limited focus. For example, results enhancement engine 74 may be used to determine by segmentation and comparison when a specific query is likely to be from a search engine user 28 considering the purchase of a new car. Related activity group 66 might then be a group having a common interest in a particular car, such as a car club sponsored for example for that car. In this case, results enhancement engine 74 might then enhance the search results with additional, and typically favorable, search results from the car club and/or charge the car dealer, manufacture or car club for such listing in a conventional manner.

As shown in FIG. 3, results enhancement engine 74 may have access to a plurality of secondary indexes each of which may include data indexed from a plurality of different related activity groups 66. In another example, the indexes of both a representative cross section of news sources and a specific set of one or more non-representative sources such as a car club sponsored by the manufacturer, could be made available to engine 74 so that the results set for queries likely to be related to new car purchases (or purchasers) include both representative news data as well as non-representative car data.

There may also be many different manners of operation of results enhancement engine 74 in the way in which search results from secondary index 72 were added to the search result set provided to user 28. For example, all secondary search results (e.g. those provided as a result of the relatedness of secondary index 72) could be separately grouped and/or otherwise separately identified. In preferred embodiments, however, all secondary search results would be intermixed with the primary search results by enhancement engine 74. The intermixing could be on an arbitrary basis, e.g. the secondary index search results could be inserted between primary index search results as the third, fifth and seventh entries in the result set.

The secondary search results can be ranked and intermixed with the primary search results on the basis of ranking, e.g. the three highest secondary search results can be inserted between primary index search results as the third, fifth and seventh entries in the result set. The system used to rank the secondary search index results can be the same or similar to the system used to rank the primary index search results and/or the secondary search results can be weighted or scaled so that the secondary search results are intermixed with the top few primary search results. For example, the ranking of the secondary search results can be scaled, based on knowledge of the ranking of the top few or first page of primary search index results, so that each of the secondary search results were intermixed in their ranked and weighted order with respect to the other secondary search index results but intermixed within the top few primary search index results.

Referring now in greater detail to results enhancement search engine 74 in FIG. 3, the search query received from search engine site 86 may be parsed or segmented by query segmentation engine 86 to determine if the query is likely to be related to a specialized field, for example, a specialized field for which secondary index 72 is an index of search results such as current or recent news events.

For example, query segmentation engine 86 may determine if the number of occurrences of each segment or pattern, such as a word or phrase n-gram of the query, appropriately matches segments having at least a particular minimum weight or score in one or more secondary indexes, such as secondary index 72. Rules may be developed to determine if a particular query is related to any particular secondary index 72. For example, query segmentation engine 86 may determine that more than 3 segments of the query are each present in secondary index 72 more than 4 times each, each with a likely importance weighting value of 2. The relevant rule may be that the query is related to secondary index 72 if some function of the number of segments present in secondary index and the number and/or likely importance or weighting of the presence of these segments exceeds a threshold value. For example, the rule may be that if the product of the number of query segments found in index 72 times the number of times each is present times the weighting factor for each time each is present exceeds 24, then the query is related to secondary index 72.

Once a relationship is determined to exist with one or more secondary indexes, such as index 72, a selected group of related sources or URLs such as those included in index 72 or from which the data in index 72 was extracted, e.g. database 70, or other search results, or a subset of such results, are provided to combiner 84. Secondary index 72, and/or database 70, is preferably built before the query is provided so that the relatedness determination and/or the potential search result set from secondary index 72 and/or database 70 is provided to combiner 84 in search results enhancement engine 74 with minimum latency from time that the potential search results set is received from primary or web index 78.

Combiner 84 may serve to rank, weight and/or scale either or both the results sets from primary index 78 and secondary index 72 (or combined secondary index 73) to form a desired search results set which may be provided via search engine site 30 directly or indirectly to user 28 in response to the query from user 28.

Referring now to FIG. 4, a primary function of query segmentation engine 86 is to determine if the query is sufficiently related to the data collected from the related activity group, such as news sites 90, 92, 94, 96 and 98, so that results derived from related activity 66 should be included from secondary index 73 and/or in the results set provided to user 28.

It is important to note that combining data from secondary database 70 without determining relatedness may be used to provide an improvement in the relevance of result sets for certain types of queries. For example, a database related to trusted news sites may be used to improve the relevance of search result sets for queries related to current events, for example, queries about the news based, for example, upon a selection made by the person. On the other hand, simply directly including search results from a focused group of sources, such as a related activity group, may not always improve and may actually reduce the relevancy of the results set provided to user 28.

One way to improve search result set relevance for a particular query is therefore to determine relatedness, e.g. if a particular query is timely, that is, if the query is related to an event sufficiently recent, then current news sites would be likely to include information relevant to that event. For example, a query including the key words “Bush” and “speech” may produce a result set including a large percentage of results related to talks given on gardening. The addition of search results related to President Bush may then substantially improve the relevance of the result set if the query was, or was likely to be, related to politics.

One level of improved relevance would likely result from including a larger percentage of search results from news sites, than from a conventional web index such as index 78, if the query was related to politics. Segmentation of the query to determine relatedness by analysis of particular patterns, such as n-grams, may be useful to further enhance the likelihood that a particular query is related to a particular group of selected sites such as news sites.

In a preferred embodiment bigrams, that is an n-gram including a group of two words which occur in a particular sequence, may be used to determine the relevancy or relatedness of indexed data to a query. For example, a query may be determined to include a particular pattern, such as the bigram “Bush speech”. A review of news sites may determine that the same bigram appears a significant number of times. The relevance of the results set provided to search engine user 28 may then be improved by the inclusion of information from the news sites in a relatively prominent position in the set of search results.

It is preferable to improve search result set relevance in an automated way, without requiring substantial human intervention. In many if not most applications, it is also important to provide the improvement with little or no latency. That is, additional delay required in order to provide improved results may not be desirable.

One way to automate and implement results enhancement engine 74 (shown in FIG. 3) is to utilize pattern matching, for example, by segmenting the query into n-grams such as bigrams and/or trigrams and evaluating data from related activity group 66. In particular, data may be collected from a data source 100. In one embodiment, data source 100 may be an index used to provide secondary search results to results enhancement engine 74 without a determination of relatedness. The data in source data 100 may then be parsed in order to store the contents of each source of data, as well as the pointer to each such source of data, e.g. a URL from a selected website in database 102. Source data 100 may be used directly in lieu of creating database 102 if source data 100 includes both URLs and their contents. N-gram patterns identifier 104 is then used, for example, to identify bigrams in database 102. It may be desirable to determine in which portions of the data source the bigrams appear so that relevance weighting factors may be applied, for example, if the bigram appears in the URL, or in the title of a document referenced by a URL, or in a headline section of a web page referenced by a URL.

In alternate embodiments, other patterns including other n-grams, may be detected and used. For example, in some embodiments, it may be useful to detect and score both bigrams and trigrams or other multiple patterns.

The output of pattern identifier 104 may then be in the form of a set of bigram records. Each data record would include the bigram or other pattern as well as one or more scoring or weighting entries. In some embodiments, each record may include an indication of the source of the bigram, such as a URL, so that the URLs may be provided directly to combiner 84 (shown in FIG. 3). The data record for each bigram may preferably also include one or more scoring or weighting factors including information related to the number of occurrences of the bigram in that URL and/or the number of unique hosts, for that bigram, as a score. For example, a score may be included in each record based on the total number of occurrences multiplied by the number of unique hosts or URLs on which the data is present. The score may be increased by the number of occurrences which were in the title of the article or website. The records of each secondary index 72, or secondary index 73, may then be sorted by the weights and/or scores for each bigram.

A similar parsing or pattern creation may also be applied to the query. Search engine site 30 may apply the query to the same or a similar instance of n-gram pattern creator 104 which detects and identifies bigrams so that the patterns in the query may be compared to the index of patterns previously prepared and stored in secondary indexes 72 or 73. It is important to note that latency is substantially reduced or eliminated by preparation of the secondary index before processing the query. In particular it may be desirable to create or update the secondary index, or portions thereof, on a regular basis. For example, it may be desirable to create or update a secondary index related to news websites several times per day because of the timeliness of news data. A secondary index related to gardening magazines may be updated or created based on the slower publication cycle of such magazines.

In a preferred embodiment, in order to minimize latency, it may be desirable to convert the query and indexed patterns or bigrams with hash tables 106 so that matcher 106 may quickly determine if there is a sufficient match or relatedness between the query patterns and patterns detected, scored and stored in secondary index 73. An output from matcher 108 indicating a match may be applied to combiner 84 to cause at least some of the URLs in secondary index 73, or in a separate source of data such as data source 100, preferably based on the relative scoring of the bigrams, to be included within the results set provided by search engine site 30 directly or indirectly to search engine user 28.

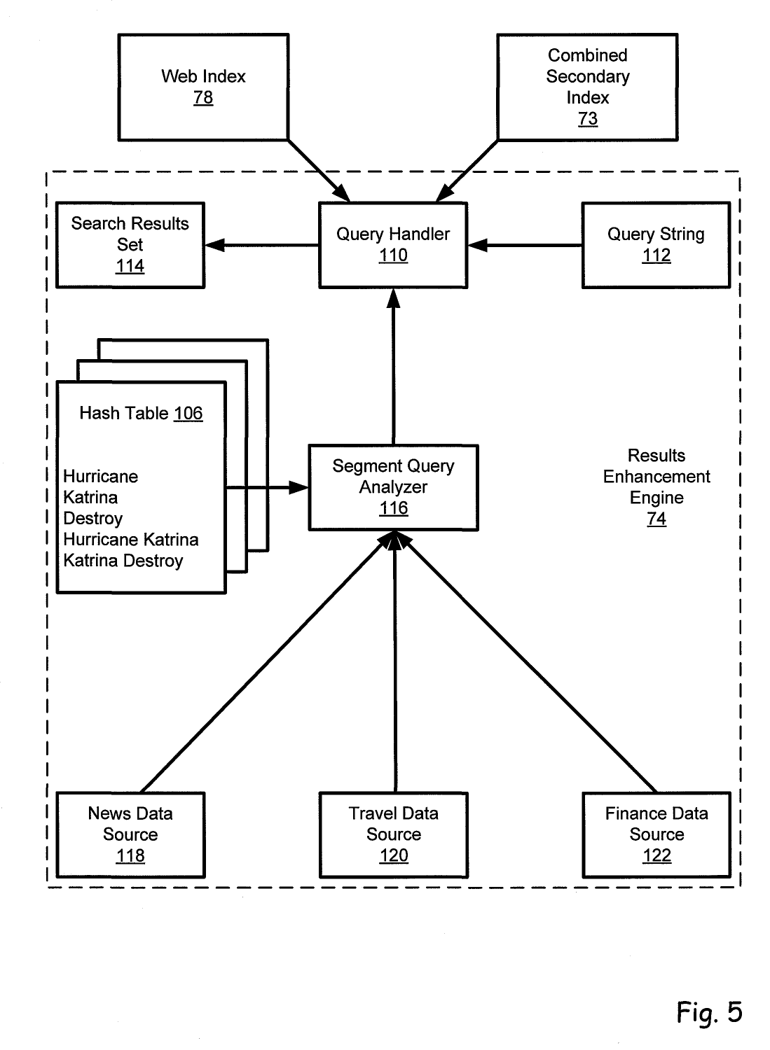

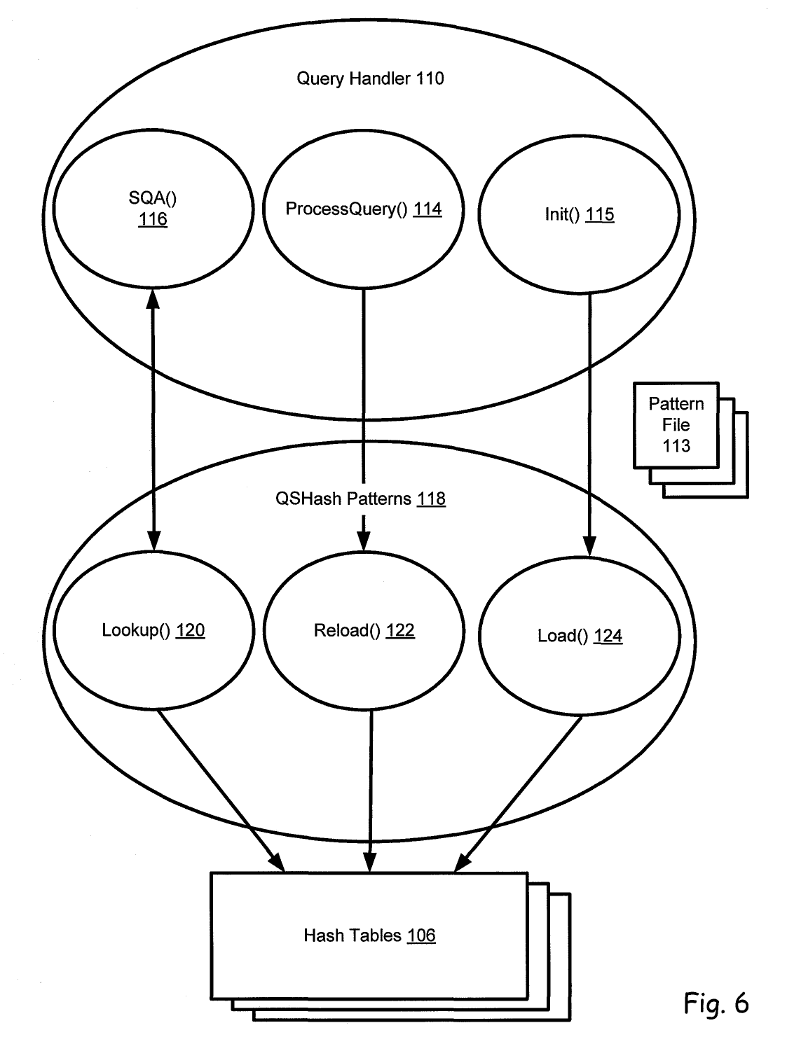

Referring now to FIG. 5, results enhancement engine 74 may include query handler 110 which processes web index 78 and secondary combined index 73 in response to received query string 112, which may be the query string “hurricane Katrina destroy” to produce search results set 114 for user 28. The patterns, in this case unigrams and bigrams, derived for example from combined secondary index 73 are stored in hash tables 106 which is applied to segment query analyzer or SQA 116. A pattern file, described below with regard to FIG. 6, may be created for each type of pattern, such as bigram, for each category or data source, such as news data source 118, travel data source 120 and finance data source 122, which pattern files are also provided to SQA 116. A hash table 106 can then be created for each category. Query handler 110 may be acquiring search results from web index 78 while SQA 116 checks relatedness in each of the category specific hash tables 106.

In operation, query handler 110 operates on web index 78 to select queries matching query string 112. In addition, query string 112 is segmented to identify patterns and SQA 116 analyzes hash tables 106 to determine, at a minimum, if each pattern is represented in one or more of the category specific hash tables. During segmentation or pattern derivation, unimportant or common words are ignored, such as definite and indefinite articles, etc. which would not be useful in searching to locate specific results. The unigrams and bigrams in query string 112 are converted to hashes and compared with hash table 106 which may include, for example, unigrams and bigrams from news data source 118 such as hurricane, Katrina, destroy, Hurricane Katrina and Katrina destroy. SQA 116 would then likely determine that news data source 118 had sufficient level of relatedness to query string 112, that is, patterns in query string 112 were a match for patterns derived from news data source 118.

SQA 116 would therefore apply query string 112 to news data source 118 to derive additional search results which would be provided by query handler 110 to the source of query string 112 in search results set 114. In alternate embodiments, combined secondary index 73 or hash table 106 may provide a pointer to such additional search results. Similarly, additional information may be retrieved by SQA 116, from each positive match in hash tables 106, such as the rank and score for the matching hash key. As an example, SQA( ) 116 causing Lookup( ) 120 to apply the hash key for “white house” to a hash table 106 for news data source 118 may derive the additional information that “white house” has a score of 193068 and a rank of 1. As noted above, the scores, rank and other weighting factors, including title, related to an identified pattern such as a bigram, may be used to determine the relative position of search results from a secondary index within search results set 114.

Additional hash tables 106 might also include similar patterns from travel data source 120 and/or finance data source 122 which SQA 116 would also provide to query handler 110 to include in search results set 114.

Referring now also to FIG. 6, a high level function overview of query segmentation engine 86 is shown including query handler 110, hash patterns 118 and hash tables 106. Query handler 110 may include SQA( ) 116 which communicates with lookup( ) 120 in QSHashpatterns 118 to identify matches in hash tables 106 to patterns found in query 112.

Once a hash key has been generated for a particular pattern, such as a bigram, the same key is used for all of the hashes. A hash key for the bigram “white house” derived by ProcessQuery( ) 114 would be unique to the “white house” bigram, but that hash key would be used for the “white house” bigram in query 112 as well as for the same bigram in each of hash tables 106 related to data sources 118, 120 and 122. The use of a common hash key for each pattern, such as the “white house” bigram, substantially reduces latency by reducing the time required to search all hash tables 106 for the same hash key.

Init( ) 115 causes hashes of pattern files 113, related to secondary or data sources or indexes, to be loaded in hash tables 106 via Load( ) function 124 when query handler 110 is initialized. ProcessQuery( ) 114 causes hashes of pattern files 113 to be reloaded into hash tables 106 via Reload( ) 122 when a query is being processed. Reload( ) 122 may also be called at regular intervals, preferably only if the pattern files have been changed.

N-gram pattern identifier 104 may generate pattern files 113 for each type of pattern identified from a particular category or data source. Each of the pattern files 113 may contain only one n-gram pattern such as a unigram or a bigram. Each pattern file 113 file name may include a prefix, a category name such as “News” reflecting the related activities group 66 or other data source as well as an indication of the type of the pattern, such as 1 for a unigram, 2 for a bigram and 3 for a trigram.

Each such file pattern file 113 may have a header including values for category name, expiration of the file after creation, reload interval if changed and a time stamp indicating the last change. A sample of a pattern file for bigrams derived from news related sources may be named Pattern_file_{—}0_{—}1 and include:

| ######################################### | | | |
|---|---|---|---|
| category=news | | | |
| last_changed=1127331202 | | | |
| expire=86400 | | | |
| interval=10800 | | | |
| ######################################### | | | |
| 193068 | 519 | 292 | white house |
| 180600 | 645 | 200 | supreme court |
| 152640 | 360 | 394 | prime minister |
| 85800 | 429 | 170 | president bush |

The header identifies the category as news and indicates the number of seconds related to the last change, the expiration of the pattern file and the interval until the next reload. The body of the file has 4 columns. Using the bigram record for “white house” as an example, a total score of 193068 in this example means that the bigram “white house” is the bigram with the highest score in the new category, that is, it has a rank of 1. The second column may indicate that there were 519 occurrences of the bigram during the relevant period from 292 unique hosts or websites. The product of 519 and 292 is less than 193068 by 41520 which represents the additional scoring values for this bigram derived for example by some number of the 519 occurrences being in the title of the website article.

1. A method of delivering search results, comprising:
applying a query from a searcher to a primary index of words on Internet websites to produce a first set of search results;
segmenting the query to obtain one or more word groups, each word group including a predetermined number of words;
analyzing each word group to determine a degree of relatedness between that word group and a group of Internet websites related to each other by a common factor;
applying each word group to a secondary index of words in the group of related websites, if that word group has a predetermined level of relatedness to the group of related websites, to produce a second set of search results; and
combining the first and second set of search results to produce a combined set of search results for the searcher.

2. The method of claim 1 wherein the common factor is related to subject matter common to the group of related websites.

3. The method of claim 2 wherein analyzing each word group to determine a degree of relatedness between that word group and a group of Internet websites related to each other by a common factor further comprises:
comparing the word group to the secondary index of the related group of websites.

4. The method of claim 1 wherein the common factor among the group of related websites is that each of the common websites is primarily news website.

5. The method of clam 3 wherein analyzing each word group to determine a degree of relatedness between that word group and a group of Internet websites related to each other by a common factor further comprises:
determining the timeliness of the word group with respect to current news by determining if the word group is present in news provided on a substantial number of the news websites in the group during a predetermined time period before the word group is analyzed.

6. The method of claim 1 wherein segmenting the query to obtain one or more word groups further comprises:
identifying a pattern including the predetermined number of words.

7. The method of claim 6 wherein identifying a pattern including the predetermined number of words further comprises:
identifying an order in which the predetermined number of words appear in the query.

8. The method of claim 6 further comprising:
segmenting text associated with each website in the group of related websites into word groups having the same number of predetermined words to form the secondary index.

9. The method of claim 8 wherein segmenting text associated with each website into word groups having the same number of predetermined words to form the secondary index
identifying a pattern in an order of appearance of the predetermined number of words.

10. A method of delivering search results, comprising:
segmenting a query into one or more nGrams, each nGrams having n words appearing in a predetermined sequence;
forming a table of nGrams appearing in at least one group of websites; and
providing a search result set in response to the query from the at least one group of websites if the query nGrams have a sufficient match to the nGrams of the at least one group of websites.

11. The method of claim 10 wherein n is equal to two.

12. The method of claim 10 wherein forming a table of nGrams appearing in at least one group of websites further comprises:
matching hash tables of the query nGrams to hash tables of the n-grams of the at least one group of websites.

13. The method of claim 12 wherein matching hash tables further comprises:
maintaining hash tables for nGrams of the at least one group of websites.

14. The method of claim 13 wherein maintaining hash table further comprises:
analyzing the at least one group of websites to identify nGram patterns;
forming an index of the nGram patterns; and
maintaining a hash table of the index of nGram patterns.

15. The method of claim 10 providing a search result set in response to the query from the at least one group of websites if the query nGrams have a sufficient match to the nGrams of the at least one group of websites further comprises:
determining the relatedness of the query nGrams to nGrams of each of the plurality of groups of websites; and
providing search results from each of the plurality of groups of websites having a predetermined level of relatedness between nGrams of that groups of websites and the query nGrams.

16. The method of claim 15 wherein the predetermined level of relatedness is different between different ones of the plurality of groups of websites.

17. The method of claim 16 wherein the websites within each of the plurality of groups of websites are related to each other by a common factor.

18. The method of claim 17 wherein the common factor in one of the predetermined groups of websites is that each such websites is a news website.

19. The method of claim 18 wherein the predetermined level of relatedness is related to how recently the nGrams appeared in each such news website.

20. The method of claim 17 wherein the common factor in one of the predetermined groups of websites is that each such websites is a travel or financial data website.
